(19) United States
(12) Patent Application Publication
(10) Pub. No.: US 2010/0045847 A1
(43) Pub. Date: Feb. 25, 2010

(54) INTEGRATED IMAGE SENSOR WITH SHUTTER AND DIGITAL CAMERA INCLUDING THE SAME

(75) Inventor: Hun-young Ryu, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/540,797

(22) Filed: Aug. 13, 2009

(30) Foreign Application Priority Data
Aug. 21, 2008 (KR) 10-2008-0081859

(51) Int. Cl. H04N 5/225; H04N 5/235

(52) U.S. Cl. 348/341; 348/362; 348/E05.037; 348/E05.024

(57) ABSTRACT

Provided are an integrated image sensor with a shutter and a digital camera including the same. The integrated image sensor with a shutter includes: an image sensor converting an image signal that has passed through a lens unit, into an electrical signal; a functional polarization film that is disposed on an optical path between the lens unit and the image sensor and opens or closes the optical path according to a turn-on/turn-off of an operational voltage; and a first transparent electrode and a second transparent electrode respectively disposed on either side of the functional polarization film and applying the operational voltage. Accordingly, the integrated image sensor with a shutter includes a shutter structure that opens or closes the optical path of an image signal by receiving an electric signal, wherein the shutter and the image sensor are integrally formed as a single unit.

### CROSS-REFERENCE TO RELATED PATENT APPLICATION

This application claims the benefit of Korean Patent Application No. 10-2008-0081859, filed on Aug. 21, 2008 in the Korean Intellectual Property Office, the disclosure of which is incorporated herein in its entirety by reference.

### BACKGROUND OF THE INVENTION

1. Field of the Invention

The present invention relates to an integrated image sensor with a shutter and a digital camera including the same, and more particularly, to an integrated image sensor with a shutter and a digital camera having a shutter structure that opens or closes an optical path of an image of a subject according to whether an electrical driving signal is applied or not, wherein the shutter and the image sensor are integrally formed as a single unit.

2. Description of the Related Art

A camera generally includes a focal plane shutter as a shutter element for adjusting the amount of light of a subject that is incident through a lens group. The focal plane shutter includes an upper curtain and a lower curtain which block a screen of an image sensor and operate together at the same time with the operation of a shutter button, thereby functioning as a shutter. Just before a photographing operation, the lower curtain is in a position blocking the image sensor screen and the upper curtain is on standby. When the photographing operation is started, the lower curtain is moved, a slit opening is exposed, and the upper curtain is moved after the lower curtain, and an image of the subject is input through the slit opening proceeding from an upper end to a lower end of the image sensor. Thus, image data is obtained.

However, due to the complicated operational mechanism of the focal plane shutter, it is difficult to control the upper curtain and the lower curtain to move simultaneously. Also, unevenness of exposure is caused due to the difference in the light amounts within one screen because the exposure amount of light varies according to the difference in the moving speed of the upper and lower curtains. For example, when a shutter time is 0.12 msec and the upper curtain is moved only 0.1 msec later than the lower curtain, the exposure time of the upper end of the image sensor is 0.12 msec, but the exposure time of the lower end is 0.22 msec. Thus, the exposure time of the lower end of the image sensor is almost twice the exposure time of the upper end of the image sensor.

To overcome this problem, it is necessary to adjust the upper and lower curtains, and this requires a complicated manufacturing process. Moreover, since an image cannot be captured exactly at the same time for the upper and lower ends of a subject, it is difficult to synchronize flash light for photographing with a flash mode.

### SUMMARY OF THE INVENTION

The present invention provides an integrated image sensor with a shutter having a shutter structure opening or closing the optical path of an image of a subject according to whether an electrical driving signal is applied or not, wherein the shutter and the image sensor are integrally formed as a single unit.

The present invention also provides a digital camera including the integrated image sensor with a shutter.

According to an aspect of the present invention, there is provided an integrated image sensor with a shutter, comprising: an image sensor converting light of an image of a subject that has passed through a lens unit, into an electrical signal; a functional polarization film that is disposed on an optical path between the lens unit and the image sensor and opens or closes the optical path according to a turn-on/turn-off of an operational voltage; and a first transparent electrode and a second transparent electrode respectively disposed on either side of the functional polarization film and applying the operational voltage.

The functional polarization film may comprise a plurality of polarization particles which have irregular polarization orientation when the operational voltage is turned off and have a polarization orientation aligned according to an electric field when the operational voltage is turned on.

The functional polarization film and the image sensor may be integrally formed as a single unit.

The integrated image sensor with a shutter may further comprise an optical filter disposed on the optical path between the lens unit and the image sensor and optically correcting an image of a subject. The image sensor, the functional polarization film, and the optical filter may be integrally formed as a single unit.

The optical filter may comprise at least one of an optical low pass filter, an ultraviolet ray blocking filter, a dichroic mirror, and a phaser filter.

The integrated image sensor with a shutter may further comprise a surface protection film disposed on a side of each of the first and second transparent electrodes, opposite to the side of which the functional polarization film is disposed on.

The integrated image sensor with a shutter may further comprise a front substrate disposed at the side of the functional polarization film facing the lens unit, and a rear substrate disposed at the side of the functional polarization film facing the image sensor.

According to another aspect of the present invention, there is provided a digital camera comprising: a lens unit through which light of an image of a subject is incident; a reflection mirror selectively diverting the light of the image of the subject that has passed through the lens unit to a first optical path or to a second optical path; a penta prism disposed on the first optical path; a viewfinder disposed on an exit path of the penta prism; an image sensor disposed on the second optical path and converting the image of the subject into an electrical signal; a functional polarization film that is disposed between the lens unit and the image sensor and opens or closes the second optical path according to a turn-on/turn-off of an operational voltage; and a first transparent electrode and a second transparent electrode respectively disposed on either side of the functional polarization film and applying the operational voltage.

The reflection mirror may be rotated around a rotation axis to selectively convert the optical path of an image to the first optical path or the second optical path.

The reflection mirror may convert the optical path of an image of a subject according to the operation of a shutter button from the first optical path to the second optical path.

The functional polarization film may comprise a plurality of polarization particles which have irregular polarization orientation when the operational voltage is turned off and have a polarization orientation aligned according to an electric field when the operational voltage is turned on.

The functional polarization film and the image sensor may be integrally formed as a single unit.

The digital camera may further comprise an optical filter disposed on the optical path between the lens unit and the image sensor and optically correcting an image of a subject. The image sensor, the functional polarization film, and the optical filter may be integrally formed as a single unit.

The digital camera may further comprise a front substrate disposed at a side of the functional polarization film facing the lens unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a vertical cross-sectional structure of a digital single lens reflex (DSLR) digital camera, according to an embodiment of the present invention;

FIGS. 2A and 2B are schematic views illustrating on and off states of a shutter unit illustrated in FIG. 1, for explaining the operational principle of the shutter unit, according to an embodiment of the present invention;

FIG. 3 is a schematic view illustrating a vertical cross-section of an integrated image sensor with a shutter illustrated in FIG. 1, according to an embodiment of the present invention;

FIG. 4 is a vertical cross-sectional development view illustrating the integrated image sensor with a shutter illustrated in FIG. 3 along an optical axis, according to an embodiment of the present invention;

FIG. 5 is a schematic view illustrating another example of the integrated image sensor with a shutter illustrated in FIG. 3, according to another embodiment of the present invention; and

FIG. 6 is a schematic view illustrating image distortion occurring during a wide angle photographing operation.

### DETAILED DESCRIPTION OF THE INVENTION

The present invention will now be described more fully with reference to the accompanying drawings, in which exemplary embodiments of the invention are shown. In this specification, a digital camera refers to a digital mobile device having a proper photographing function, meaning not only a camera of a narrow concept classified simply by the form of a camera but also digital devices of a broader concept which has both portability and a photographing function, such as a camcorder, a mobile phone, a personal digital assistant (PDA), and so forth.

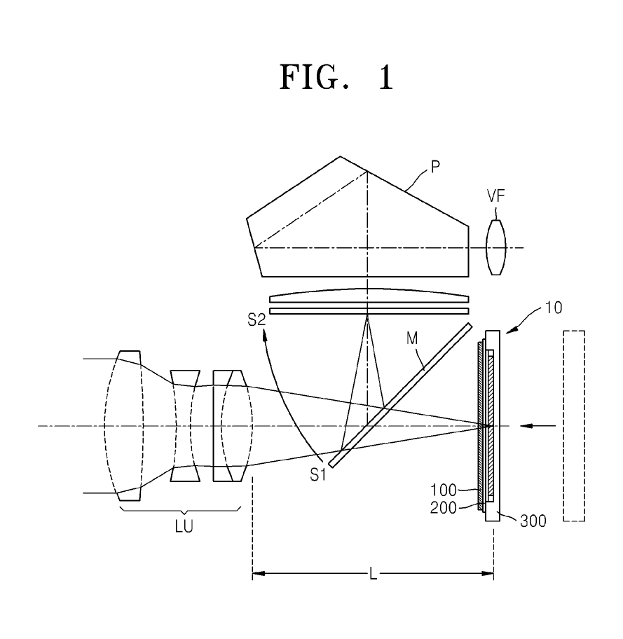

FIG. 1 is a schematic view illustrating a vertical cross-sectional structure of a digital single lens reflex (DSLR) digital camera, according to an embodiment of the present invention. Referring to FIG. 1, the DSLR digital camera according to the present embodiment includes a lens unit LU capturing an image of a subject, a reflection mirror M that rotates between a first position S1 and a second position S2 to selectively divert the light of the image of the subject that has passed through the lens unit LU to a viewfinder VF or an integrated image sensor 10 with a shutter, a penta prism P disposed on an optical path between the reflection mirror M and the viewfinder VF and guiding the light of the image of the subject to the viewfinder VF by total internal reflection. The integrated image sensor 10 with a shutter converts an image signal of the subject that has passed through the lens unit LU into an electrical signal.

The reflection mirror M rotates between the first position S1 and the second position S2 according to the operation of a shutter button, and guides the light of an image of a subject through the lens unit LU to the viewfinder VF when the reflection mirror M is at the first position S1. As the shutter button is pressed, the reflection mirror M is abruptly raised from the first position S1 to the second position S2, and the image signal incident through the lens unit LU proceeds in a straight line and is formed as an image on the integrated image sensor 10 with a shutter.

The integrated image sensor 10 with a shutter includes a shutter unit 100 at the front and a sensor unit 300 at the back, and the shutter unit 100 and the sensor unit 300 are closely coupled to each other, forming a single unit. The shutter unit 100 may be realized as a smart window whose light transmittivity changes according to an electric input. When external power is not supplied, the shutter unit 100 is maintained in an opaque state, blocking the optical path of an image. When external power is supplied, the shutter unit 100 becomes transparent and opens the optical path. In this manner, the shutter unit 100 opens or closes the optical path. Examples of the smart window forming the shutter unit 100 are a liquid crystal display (LCD), a suspended particle display (SPD), an electrochromic glass (EC), a photochromic glass (PC), a thermo-chromic glass (LTC), and so forth, according to the type of functional materials. When necessary, an optical filter 200 may be interposed between the shutter unit 100 and the sensor unit 300 to optically correct the image of the subject.

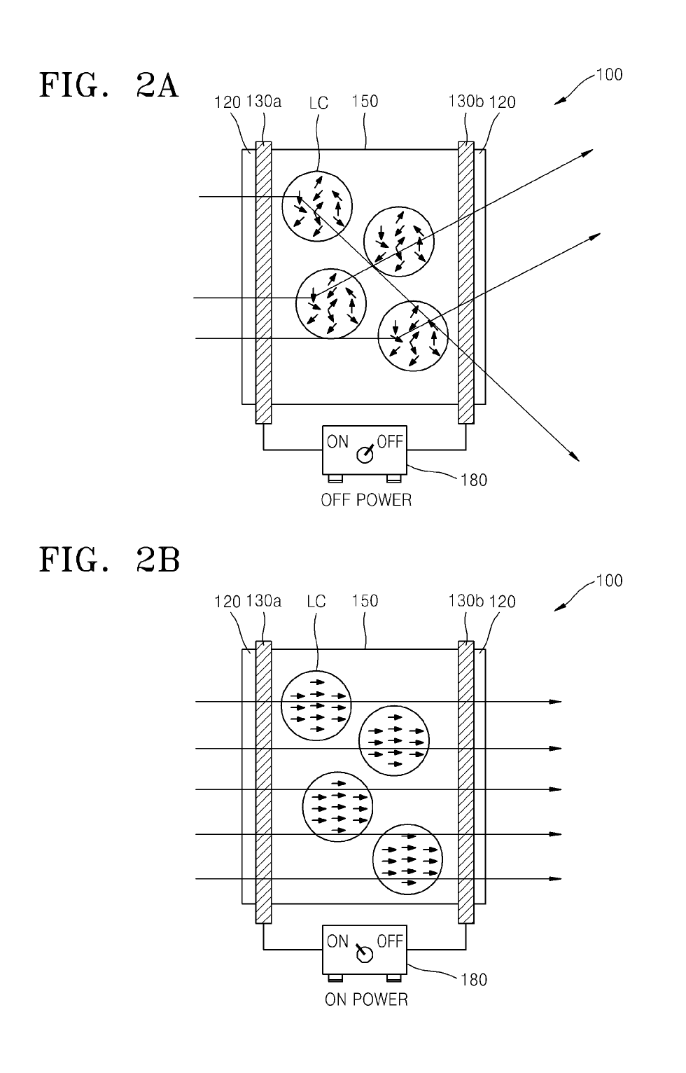

FIGS. 2A and 2B are cross-sectional views respectively illustrating on and off states of the shutter unit 100 to which a polarization particle dispersion method is applied, for explaining the operational principle of the shutter unit 100, according to an embodiment of the present invention. To help understanding, some layers are enlarged for illustrative purposes. Referring to FIGS. 2A and 2B, a functional polarization film 150, in which liquid crystals including polarization particles are distributed, is interposed between first and second transparent electrodes 130a and 130b, and the first and second transparent electrodes 130a and 130b are connected to a power supplying unit 180 that applies an operational voltage between the transparent electrodes 130a and 130b. For example, the power supplying unit 180 may turn on and off an operational voltage under the control of a digital signal processor (not shown) which controls elements of a digital camera.

Referring to FIG. 2A, in a turn-off state in which no operational voltage is applied between the first and second transparent electrodes 130a and 130b, polarization particles that are present inside the liquid crystals move according to random Brownian motion, and thus incident light is absorbed and diffused. As a result, the functional polarization film 150 assumes a dark-colored state, and light is blocked and thus not incident to the sensor unit 300. This state is referred to as a shutter-off state. Referring to FIG. 2B, when an operational voltage is applied between the first and second transparent electrodes 130a and 130b, the polarization particles that are present in the liquid crystals (LC) are aligned according to the applied electric field, and thus allow light to pass through the functional polarization film 150. Consequently, light of an image of a subject arrives at the sensor unit 300 and the image of a subject is captured by the sensor unit 300. This state is referred to as a shutter-on state.

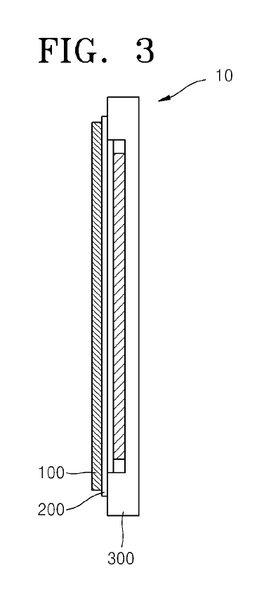

FIG. 3 is a schematic view illustrating a vertical cross-section of the integrated image sensor 10 with a shutter illustrated in FIG. 1, according to an embodiment of the present invention. The integrated image sensor 10 with a shutter includes the shutter unit 100 and the sensor unit 300 that are closely coupled to each other, forming a single unit. ‘Coupled as a single unit’ means that the elements are closely coupled to each other such that they are not separated from each other unless as a result of physical damage. When necessary, an optical filter 200 may be interposed between the shutter unit 100 and the sensor unit 300 to optically correct the image of the subject.

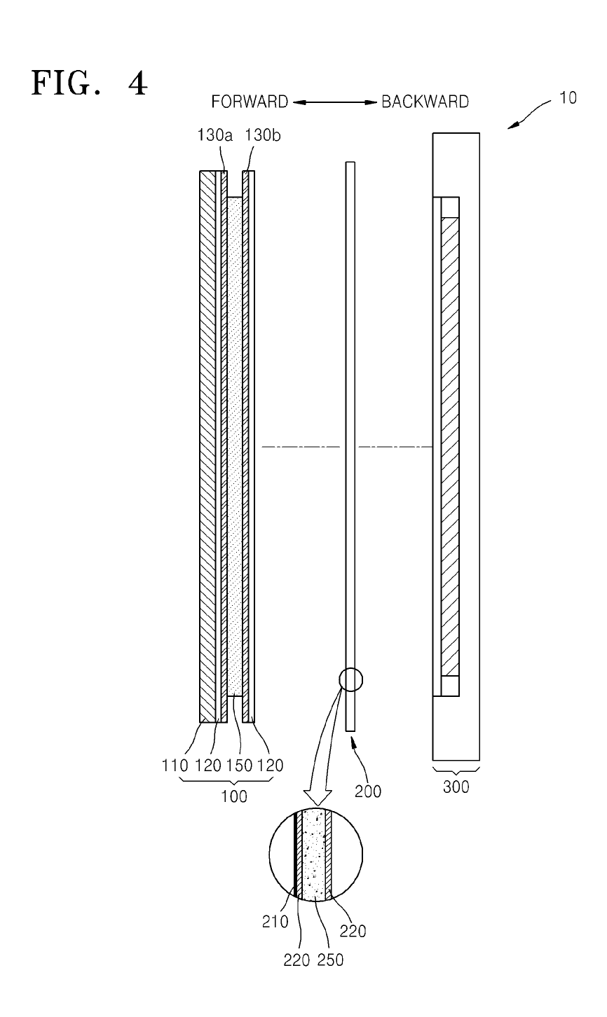

FIG. 4 is a vertical cross-sectional development view illustrating the integrated image sensor 10 with a shutter illustrated in FIG. 3 along an optical axis, according to an embodiment of the present invention. For convenience of understanding, some layers are enlarged for illustrative purposes. Referring to FIG. 4, the shutter unit 100 functions as a shutter that selectively opens or closes the optical path of light that has passed through the lens unit LU. The shutter unit 100 includes the functional polarization film 150 including a plurality of polarization particles, the first and second transparent electrodes 130a and 130b facing each other and having the functional polarization film 150 therebetween, and a front substrate 110 formed as the external surface of the shutter unit 100. The front substrate 100 may be formed of a glass substrate formed of glass or an optical plastic material such as polyethylene terephthalate (PET), having insulation characteristics and optical transparency, and protects the exposed external surface of the integrated image sensor 10 with a shutter. The functional polarization film 150 has a structure in which a suspension including polarization particles is dispersed in a polymer resin as fine liquid crystals. When no electric field is applied, the polarization particles of the liquid crystals move according to random Brownian motion, and thus the functional polarization film 150 absorbs and diffuses light and assumes a dark-colored state, as illustrated in FIG. 2A. When an external electric field is applied, the polarization particles are aligned according to the electric field and the functional polarization film 150 is converted to an optically transparent state as illustrated in FIG. 2B.

The first transparent electrode 130a and the second transparent electrode 130b are disposed to face each other, having the functional polarization film 150 therebetween. The first transparent electrode 130a and the second transparent electrode 130b may be connected to a positive terminal and a negative terminal of the power supplying unit 180, respectively. By supplying or not supplying power between the first and second transparent electrodes 130a and 130b, the functional polarization film 150 can be selectively converted between a highly transparent state and a highly opaque state. For example, the highly transparent state refers to a state with transmittivity of the functional polarization film 150 of 60% or more. The highly opaque state refers to a state with transmittivity of the functional polarization film 150 of about 20% or less. The first and second transparent electrodes 130a and 130b may be formed of transparent conductive layers having both optical transparency and electric conductivity. For example, the first and second transparent electrodes 130a and 130b may be formed of indium tin oxide (ITO) layers.

A surface protection film 120 may be formed on a surface of each of the first and second transparent electrodes 130a and 130b. The surface protection film 120 protects the first and second transparent electrodes 130a and 130b from external harmful environmental elements such as humidity or oxygen, and may also block ultraviolet rays in order to block unnecessary components of incident light and extract visible light. Alternatively, the ultraviolet ray blocking function of the surface protection film 120 may be realized by including an additional functional film (not shown) including an ultraviolet ray absorber and/or reflector inside or outside the front substrate 110. But, in order to form the integrated image sensor 10 to be relatively thin in size, an ultraviolet ray absorber and/or reflector may be included in the surface protection film 120, thus providing multiple functionality to the surface protection film 120.

An optical filter 200 may be disposed at the back of the shutter unit 100 to optically correct an image of a subject. For example, the optical filter 200 may be an optical low pass filter 220, which is an infrared ray blocking filter. The optical low pass filter 220 excludes unnecessary infrared ray components of light that is incident from the lens unit LU, and achieves a color balance of an image sensor which is sensitive to red. The optical low pass filter 220 may be, for example, realized using an infra radiation (IR) film, a heat mirror film, and so forth, which includes an infrared ray absorber and/or reflector that selectively reacts in the infrared ray wavelengths. As illustrated in FIG. 4, the infrared ray blocking function can be realized by a separate filter element, that is, the optical low pass filter 220, but also by inserting an infrared ray absorber and/or infrared ray reflector into a layer structure of the shutter unit 100. Accordingly, the infrared ray blocking function can be implemented without an additional filter on the exterior. For example, dyes or pigments which selectively react in an infrared ray wavelength may be added to the front substrate 110. Meanwhile, a dichroic mirror 210 that selectively reflects infrared light and a circular polarization filter, that is, a phaser layer 250, which converts linearly polarized light into circularly polarized light in order to remove reflection light, may be further included in the optical filter 200.

The sensor unit 300 functioning as an image sensor may be disposed at the back of the shutter unit 100. The sensor unit 300 converts an optical image signal of a subject that is incident through the shutter unit 100 into an electric signal. The sensor unit 300 may be realized as a charged coupled device (CCD) image sensor or a complementary metal oxide semiconductor (CMOS) image sensor. In the current embodiment, a CMOS image sensor unit will be described. The sensor unit 300 includes a semiconductor substrate (not shown) in which a plurality of photodiodes are arranged, and a color filter layer (not shown) in which R, G, B color patterns are formed. Photodiodes, transistors, and wiring lines may be formed on the semiconductor substrate.

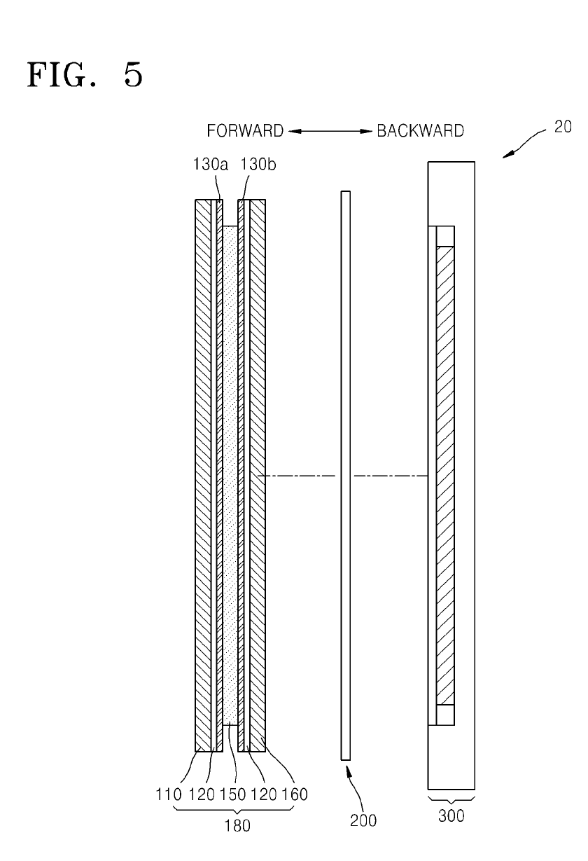

FIG. 5 is a vertical cross-sectional view illustrating an integrated image sensor 20 with a shutter, according to another embodiment of the present invention. Referring to FIG. 5, the integrated image sensor 20 with a shutter includes a shutter unit 180 selectively opening or closing the optical path of light, a filter 200 optically correcting an image of a subject, and a sensor unit 300 converting the image of the subject into an electrical signal, wherein the shutter unit 180, the filter 200 and the sensor unit 300 are coupled to one another to form a single unit. In particular, the shutter unit 180 includes a front substrate 110 and a rear substrate 160 with a functional polarization film 150 disposed therebetween. The pair of the front substrate 110 and the rear substrate 160 insulates the functional polarization film 150 and transparent electrodes 130a and 130b disposed on both surfaces of the functional polarization film 150 from the outside, thereby protecting them from external shock or scratches. Thus, the shutter unit 180 can be handled more easily during a process of coupling together the shutter unit 180 and the sensor unit 300, which are separately manufactured.

Hereinafter, a photographing operation of a digital camera in which the integrated image sensor 10 with a shutter is included will be described. Referring to FIG. 1, light of an image of a subject that is incident through the lens unit LU reaches the reflection mirror M, which is inclined at the first position S1, and reflected upward, and is guided to the viewfinder VF as the direction of the light of the image is refracted by the penta prism P. Regarding the operation of the integrated image sensor 10 with a shutter, the shutter unit 100 maintains an opaque shutter-off state to block the optical path of light that is proceeding to the sensor unit 300.

Meanwhile, when focus is adjusted on a subject using the viewfinder VF and a shutter button is pressed, a digital signal processor (not shown), which controls elements of the digital camera, rapidly rotates the reflection mirror M at the first position S1 to the second position S2 according to the shutter operation of the user. Accordingly, light of an image of a subject that has passed through the lens unit LU proceeds straight and arrives at the integrated image sensor 10 with a shutter. Meanwhile, in response to the shutter operation by the user, the digital signal processor applies an operational voltage to the shutter unit 100, and accordingly, the shutter unit 100 is converted into an optically transparent state and the light is formed as an image on the sensor unit 300 and converted into image data.

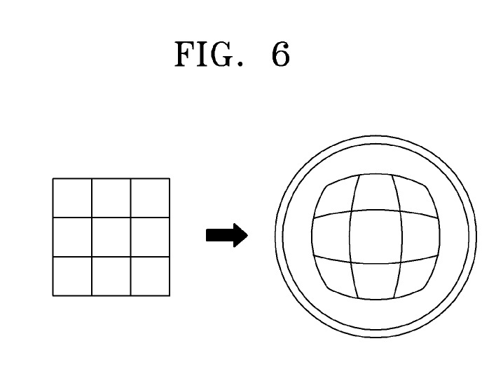

As described above, according to the present invention, the shutter unit 100 that opens or closes the optical path of light and the sensor unit 300 that converts an image signal into an electrical signal are integrally formed as a single unit, that is, a single unit (1-sheet) performing multiple functions. However, contrary to the present invention, in the case of a structure in which a shutter unit and a sensor unit are separated from each other by having a space therebetween, a functional filter forming the shutter unit and a functional filter forming the sensor unit need to be respectively inserted despite the fact that the two perform substantially the same optical correction function. This increases the overall manufacturing costs and consumes a lot of mounting space for installing the shutter unit and the sensor unit. Consequently, the thickness and weight of a camera are increased and a focal distance of a subject image is increased. In turn, image distortion of an image as illustrated in FIG. 6 cannot be prevented during a wide angle photographing operation. According to the present invention, the shutter unit 100 and the sensor unit 300 are integrally formed as a single unit, thereby reducing the thickness and weight of a camera including the shutter unit 100 and the sensor unit 300. Accordingly, the camera can have a good aesthetic appearance and a focal distance L of a subject image is reduced, thereby preventing image distortion during a wide angle photographing operation.

According to the present invention, a shutter structure that functions as an optical switch according to the conversion of orientation of polarization particles is suggested instead of a conventional focal plane shutter. Thus the arrangement of optical blocking layers demanded of the focal plane shutter is not necessary and unevenness of exposure due to the difference in the speed of the optical blocking layers can be prevented.

In particular, according to the present invention, a shutter that opens or closes the optical path of light and an image sensor that converts an image signal of a subject into an optical signal are integrally formed as a single unit. Thus, filters are not required to be inserted twice, which perform the identical optical correction function, and as a result, the manufacturing costs can be reduced and the mounting process can be completed in a single operation, thereby increasing manufacturing convenience. Also, according to the present invention, mounting space can be significantly reduced in the case of the integrated image sensor with a shutter compared to a structure in which a shutter and an image sensor are spatially separated. Thus, it is advantageous for manufacturing a thin camera while maintaining a good aesthetic appearance. Particularly, since the focal distance of a subject can be reduced, image distortion which frequently occurs during wide angle photographing operations can be removed effectively.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An integrated image sensor with a shutter, comprising:
an image sensor converting light of an image of a subject that has passed through a lens unit, into an electrical signal;
a functional polarization film that is disposed on an optical path between the lens unit and the image sensor and opens or closes the optical path according to a turn-on/turn-off of an operational voltage; and
a first transparent electrode and a second transparent electrode respectively disposed on either side of the functional polarization film and applying the operational voltage.

2. The integrated image sensor with a shutter of claim 1, wherein the functional polarization film comprises a plurality of polarization particles which have irregular polarization orientation when the operational voltage is turned off and have a polarization orientation aligned according to an electric field when the operational voltage is turned on.

3. The integrated image sensor with a shutter of claim 1, wherein the functional polarization film and the image sensor are integrally formed as a single unit.

4. The integrated image sensor with a shutter of claim 1, further comprising an optical filter disposed on the optical path between the lens unit and the image sensor and optically correcting an image of a subject.

5. The integrated image sensor with a shutter of claim 4, wherein the image sensor, the functional polarization film, and the optical filter are integrally formed as a single unit.

6. The integrated image sensor with a shutter of claim 4, wherein the optical filter comprises at least one of an optical low pass filter, an ultraviolet ray blocking filter, a dichroic mirror, and a phaser filter.

7. The integrated image sensor with a shutter of claim 1, further comprising a surface protection film disposed on a side of each of the first and second transparent electrodes, opposite to the side of which the functional polarization film is disposed on.

8. The integrated image sensor with a shutter of claim 1, further comprising a front substrate disposed at the side of the functional polarization film facing the lens unit.

9. The integrated image sensor with a shutter of claim 1, further comprising a rear substrate disposed at the side of the functional polarization film facing the image sensor.

10. A digital camera comprising:
a lens unit through which light of an image of a subject is incident;
a reflection mirror selectively diverting the light of the image of the subject that has passed through the lens unit to a first optical path or to a second optical path;
a penta prism disposed on the first optical path;
a viewfinder disposed on an exit path of the penta prism;
an image sensor disposed on the second optical path and converting the image of the subject into an electrical signal;
a functional polarization film that is disposed between the lens unit and the image sensor and opens or closes the second optical path according to a turn-on/turn-off of an operational voltage; and
a first transparent electrode and a second transparent electrode respectively disposed on either side of the functional polarization film and applying the operational voltage.

11. The digital camera of claim 10, wherein the reflection mirror is rotated around a rotation axis to selectively convert the optical path of an image to the first optical path or the second optical path.

12. The digital camera of claim 10, wherein the reflection mirror converts the optical path of an image of a subject according to the operation of a shutter button from the first optical path to the second optical path.

13. The digital camera of claim 10, wherein the functional polarization film comprises a plurality of polarization particles which have irregular polarization orientation when the operational voltage is turned off and have a polarization orientation aligned according to an electric field when the operational voltage is turned on.

14. The digital camera of claim 10, wherein the functional polarization film and the image sensor are integrally formed as a single unit.

15. The digital camera of claim 10, further comprising an optical filter disposed on the optical path between the lens unit and the image sensor and optically correcting an image of a subject.

16. The digital camera of claim 15, wherein the image sensor, the functional polarization film, and the optical filter are integrally formed as a single unit.

17. The digital camera of claim 10, further comprising a front substrate disposed at a side of the functional polarization film facing the lens unit.

18. An integrated image sensor with a shutter, comprising:
a means for converting light of an image of a subject that has passed through a lens unit, into an electrical signal; and
a means for selectively blocking an optical path to the means for converting light with at least one polarizing filter controlled by an operational voltage.

19. The integrated image sensor with a shutter of claim 18, wherein the means for selectively blocking comprises a functional polarization film including a plurality of polarization particles which have irregular polarization orientation when the operational voltage is turned off and have a polarization orientation aligned according to an electric field when the operational voltage is turned on.
